(19) United States
(12) Patent Application Publication
(10) Pub. No.: US 2026/0251203 A1
(43) Pub. Date: Aug. 27, 2026

(54) ORBICULAR GEAR MECHANISM

(71) Applicant: Mert VARDAR, Ankara (TR)

(72) Inventor: Mert VARDAR, Ankara (TR)

(21) Appl. No.: 19/162,040

(22) PCT Filed: Sep. 19, 2023
(86) PCT No.: PCT/TR2023/050980

§ 371 Date: Sep. 3, 2025

(30) Foreign Application Priority Data
Aug. 31, 2023 (TR) 2023/010704

(51) Int. Cl. F16H 1/28

(52) U.S. Cl. CPC F16H 1/28

(57) ABSTRACT

The present invention is an orbicular gear mechanism (10) configured to provide motion transfer, characterized in that; having at least one first face gear (20) and at least one second face gear (30) to rotate around a central axis (x) and transfer motion therebetween, at least one planetary gear group (40) connected to at least one shaft (45) located on a carrier (46) is connected to the first face gear (20) and said second face gear (30) for changing the gear ratios, said planetary gear group (40) comprises at least one first planetary gear (41) and at least one second planetary gear (42) each capable of rotating around itself and each extending along at least one longitudinal axis (y) assumed to be perpendicular to the central axis (x), said first planetary gear (41) and said second planetary gear (42) are connected to the same carrier (46).

### TECHNICAL FIELD

The present invention is related to an orbicular gear mechanism for transmitting motion.

### PRIOR ART

Planetary gears are a special type of gear mechanism. This mechanism generally consists of three main components. These are the central gear, planetary gears, and external gear. The central gear is located around the other gears and is usually located at a fixed central point. Planetary gears can rotate around their own axis while rotating around the central gear. This structure allows different gear ratios and motion combinations to be obtained. The design of planetary gears provides a compact and effective solution, especially in applications that require torque transformation and speed control.

In existing planetary gear mechanisms, the axes around which the planetary gears rotate are in the same direction as the axis around which the central and external gears rotate. This structure brings some disadvantages. The load distributions on the gear mechanism are not equal, and torque transmission does not reach the desired efficiency. At high speeds, due to centrifugal force, a load can occur in the radial direction of bearings on the planetary gears. In addition, the number of planetary gears in the current planetary gear mechanisms faces some restrictions, and due to the need for large bearings, a high-weight problem arises. Moreover, traditional epicyclic mechanisms face difficulties in reaching high precision gear thickness tolerance values due to production constraints.

The application known in the literature as U.S. Pat. No. 6,468,443B1 is related to an epicyclic gear arrangement for transmitting and combining torque from many sources or parallel power paths. In the aforementioned invention, a helicopter's main rotor is driven by an epicyclic gearbox containing a rotor collector gear, which is co-axial with the rotor and rotates in common, a fixed sun gear co-axial with the rotor sun gear, and at least one planet with a parallel axis. The planet mechanically includes first, and second coaxial planetary gears forced to rotate together. The structure described here is not suitable for configuring the gear mechanism for different needs in different usage areas.

In conclusion, all the problems mentioned above have made innovation in the relevant technical field mandatory.

### BRIEF DESCRIPTION OF THE INVENTION

The present invention aims to eliminate the aforementioned disadvantages and bring new advantages to the relevant technical field. It relates to an orbicular gear mechanism and its different kinematic descriptions.

One goal of the invention is to present an orbicular gear mechanism that can be structured to meet different needs in different fields.

To achieve all the goals mentioned above and that will be revealed in the detailed explanation below, the present invention is an orbicular gear mechanism configured to provide motion transfer It is characterized by having at least one first face gear and at least one second face gear to rotate around a central axis and transfer motion therebetween, at least one planetary gear group connected to at least one shaft located on a carrier is connected to the first face gear and said second face gear for changing the gear ratios, said planetary gear group comprises at least one first planetary gear and at least one second planetary gear each capable of rotating around itself and each extending along at least one longitudinal axis assumed to be perpendicular to the central axis, said first planetary gear and said second planetary gear are connected to the same carrier. Thus, compared to known planetary gear mechanisms, an orbicular gear mechanism with improved load distribution and torque transmission, and increased compactness and efficiency is presented.

A possible structure of the invention features at least one of the first face gear and the second face gear having teeth in a conical form on a face gear surface.

Another potential configuration involves both the first planetary gear and the second planetary gear being arranged on the same shaft, the first face gear being in contact with a face gear surface of the first planetary gear with a face gear surface of the first face gear, the second face gear being in contact with a face gear surface of the second planetary gear with a face gear surface of the second face gear, the first face gear being positioned in a ring direction, and the second face gear being positioned in a sun direction.

Another feature involves both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, the first face gear being positioned in a ring direction, and the second face gear being positioned in a sun direction.

Another potential arrangement has both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, both the first face gear and the second face gear being positioned in a sun direction.

Another potential arrangement has both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, both the first face gear and the second face gear being positioned in a ring direction.

Another structure involves both the first planetary gear and the second planetary gear being aligned on the same shaft, the first face gear being in contact with a face gear surface of the first planetary gear with a face gear surface of the first face gear, the second face gear being in contact with a face gear surface of the second planetary gear with a face gear surface of the second face gear, and both the first face gear and the second face gear being positioned in a ring direction.

A configuration involves both the first planetary gear and the second planetary gear being aligned on parallel longitudinal axes on two separate shafts, the first face gear being in contact with a face gear surface of the first planetary gear with a face gear surface of the first face gear, the second face gear being in contact with a face gear surface of the second planetary gear with a face gear surface of the second face gear, at least one third planetary gear being in contact with the first planetary gear and positioned on the same shaft as the second planetary gear and adjacent to the second shaft in a manner that a face gear surface of the third planetary gear contacts a face gear surface of the first planetary gear, and both the first face gear and the second face gear being positioned in a ring direction.

Another arrangement has both the first planetary gear and the second planetary gear being aligned on the same shaft, the first face gear being in contact with a face gear surface of the first planetary gear with a face gear surface of the first face gear, the second face gear being in contact with a face gear surface of the second planetary gear with a face gear surface of the second face gear, and both the first face gear and the second face gear being positioned in a sunward direction.

A feature involves both the first planetary gear and the second planetary gear being connected to two separate shafts that are parallel to each other in the longitudinal direction, the first face gear is in contact with a face gear surface of the first planetary gear with a face gear surface of the first face gear, and the second face gear is in contact with a face gear surface of the second planetary gear with a face gear surface of the second face gear, the first planetary gear on its shaft includes at least one fourth planetary gear adjacent to the first planetary gear, and the second planetary gear on its shaft includes at least one third planetary gear adjacent to the second planetary gear the third planetary gear and fourth planetary gear are in contact with each other with their planetary gear surfaces.

### BRIEF DESCRIPTION OF THE FIGURES

FIG. 1 provides a schematic representation of the A configuration of the invention's orbicular gear mechanism.

FIG. 2a shows an isometric view of the B configuration of the invention's orbicular gear mechanism.

FIG. 2b provides a schematic representation of the B configuration of the invention's orbicular gear mechanism.

FIG. 3 provides a schematic representation of the C configuration of the invention's orbicular gear mechanism.

FIG. 4 provides a schematic representation of the D configuration of the invention's orbicular gear mechanism.

FIG. 5 provides a schematic representation of the E configuration of the invention's orbicular gear mechanism.

FIG. 6 provides a schematic representation of the F configuration of the invention's orbicular gear mechanism.

FIG. 7 provides a schematic representation of the G configuration of the invention's orbicular gear mechanism.

FIG. 8 provides a schematic representation of the H configuration of the invention's orbicular gear mechanism.

FIG. 9 provides a schematic representation of the I configuration of the invention's orbicular gear mechanism.

FIG. 10 shows an isometric view of the invention's orbicular gear mechanism's first face gear and first planet gear in a possible configuration where their face gear surface and planet gear surface are in contact with each other.

### DETAILED DESCRIPTION OF THE INVENTION

In this detailed description, the subject of the invention is explained with examples that will not impose any limiting effect solely for a better understanding of the subject.

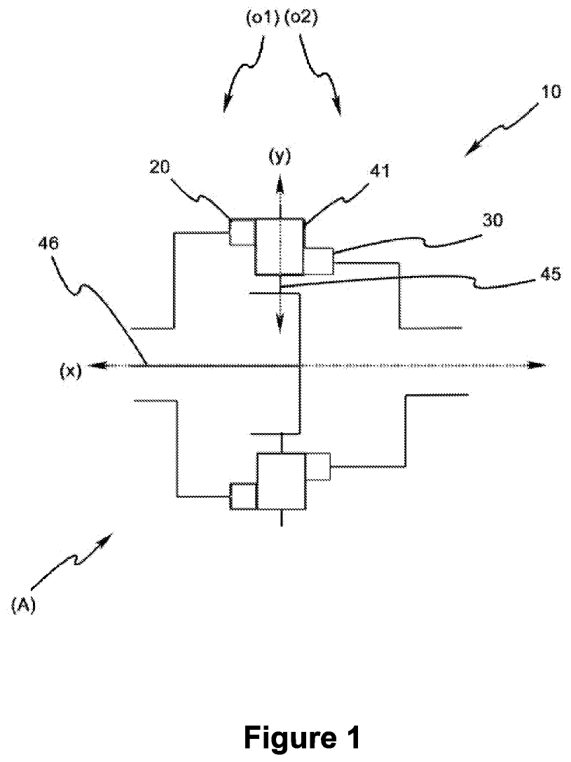

FIG. 1 provides a schematic representation of a possible A configuration (A) of the orbicular gear mechanism (10). The mentioned orbicular gear mechanism (10) is structured to transmit motion. In the general A configuration (A), the orbicular gear mechanism (10) comprises at least one first face gear (20) and at least one second face gear (30). These mentioned first and second face gears (20 and 30) are positioned parallel to each other and can rotate around a central axis (x). Both face gears (20 and 30) contain a face gear surface (s1). This face gear surface (s1) has a gear structure. Thus, the rotation movement of the first and second face gears (20 and 30) can be transferred to another gear or received from another gear.

The first face gear (20) and second face gear (30) can be positioned in a ring direction (o1) or sun direction (o2) in the orbicular gear mechanism (10). Accordingly, depending on their position in different configurations of the orbicular gear mechanism (10), they can act as ring gear or sun gear. There is at least one planet gear group (40) between the first gear (20) and second face gear (30). This mentioned planet gear group (40) includes numerous planet gears. A planet gear has a planet gear surface (s2) with a gear structure. Thus, the planet gear can transfer movement to another gear or receive movement from another gear. The planet gear is primarily connected to at least one carrier (46).

The planet gear group (40) includes at least one first planet gear (41). This mentioned first planet gear (41) transfers movement between the first face gear (20) and the planet gear group (40). The first planet gear (41) extends in a longitudinal axis (y) direction and can rotate around this axis. To achieve this, on the carrier (46), there's at least one shaft (45) that extends in the longitudinal axis (y) direction, which the planet gear (41) connects to. The longitudinal axis (y) is perpendicular to the central axis (x). Each of the first planet gears (41) extends on its longitudinal axis (y) from its center. The extensions of these longitudinal axes (y) of the first planet gears (41) intersect at the central axis (x). In the A configuration (A), the first face gear (20) and second face gear (30) are positioned opposite each other. In other words, while the first face gear (20) is positioned in the ring direction (o1), the second face gear (30) is positioned in the sun direction (o2). The face gear surfaces (s1) in the ring direction (o1) and sun direction (o2) face opposite directions from the longitudinal axis (y).

In possible configurations, the orbicular gear mechanism (10) includes at least one second planet gear (42). This mentioned second planet gear (42) rotates around the same or a parallel longitudinal axis (y) as the first planet gear (41). The first and second planet gears (41 and 42) are connected to each other by at least one carrier (46). In the orbicular gear mechanism (10), depending on the application, one of the first face gear (20), the second face gear (30), and the carrier (46) can be chosen as either an input or an output. Below are the kinematic ratio calculations for the A configuration (A).

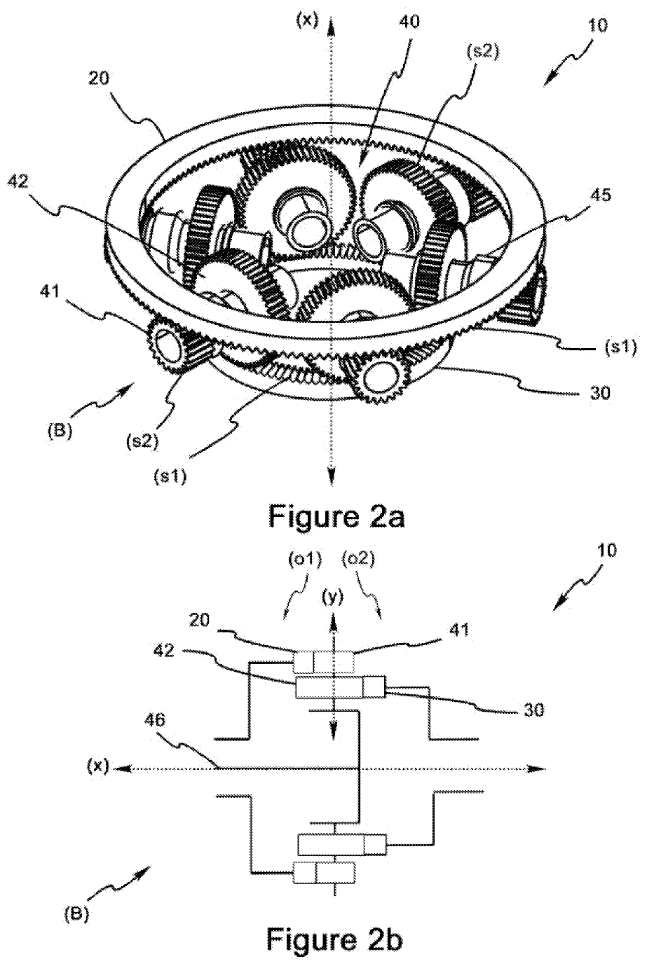

In FIG. 2a, a representative isometric view of a B configuration (B) of the orbicular face gear mechanism (10) is provided, and in FIG. 2b, a schematic representation of the mentioned B configuration (B) of the orbicular face gear mechanism is shown. The B configuration (B) includes at least one planet gear group (40) positioned between the first face gear (20) and the second face gear (30). Here, the first face gear (20) is essentially positioned in the ring gear direction (I) and functions as a ring gear, while the second face gear (30) is positioned in the sun gear direction (II) and functions as a sun gear. The planet gear group (40) comprises at least one first planet gear (41) and at least one second planet gear (42). The said first planet gear (41) is in contact with the first face gear (20) in a manner that the planet gear surface (s2) contacts the face gear surface (s1). The mentioned second planet gear (42) is in contact with the second face gear (30) in a manner that the planet gear surface (s2) contacts the face gear surface (s1). The first planet gear (41) and the second planet gear (42) are configured with different sizes. The second planet gear (42) has a larger diameter than the first planet gear (41). The sizes of the first planet gear (41) and the second planet gear (42) can be determined according to the power transmission requirements. In the B configuration (B), the first planet gear (41) and the second planet gear (42) are positioned on the same shaft (45).

In the B configuration (B), the axis around which the planetary gears rotate is the same as the central axis (x), allowing for a greater reduction ratio with more planetary gears (41) compared to a planetary gear mechanism known in the current technology. As a result, due to the high amount of load distribution, smaller bearings can be used. This leads to a reduction in size and weight.

All this described B configuration (B) is suitable for use in helicopters, with all its provided advantages. Here, the axial load on the carrier (46) is in the opposite direction of the thrust load during the helicopter's flight. This allows for a reduction in bearing size. Below are the kinematic ratio calculations for the B configuration (B).

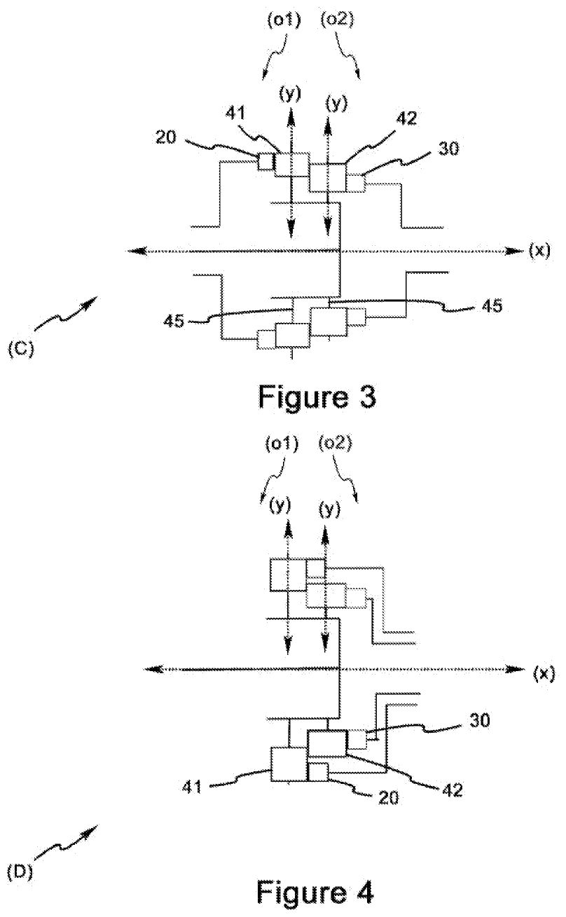

In FIG. 3, a schematic representation of a possible C configuration (C) of the orbicular gear mechanism (10) is provided. According to this C configuration (C), the orbicular gear mechanism (10) includes a first planet gear (41) and a second planet gear (42) positioned on a single carrier (46) in such a way that the planet gear surfaces (s2) are in contact with each other and they rotate around parallel longitudinal axes (y). Therefore, the first planet gear (41) and the second planet gear (42) are attached to the same carrier (46). In the C configuration (C), there are separate and parallel shafts (45) on the carrier (46) for the first planet gear (41) and the second planet gear (42). In the C configuration (C), the first face gear (20) is positioned in the ring gear direction (o1), and the second face gear (30) is positioned in the sun gear direction (o2). The face gear surface (s1) of the first face gear (20) is in contact with the planet gear surface (s2) of the first planet gear (41). The face gear surface (s1) of the second face gear (30) is in contact with the planet gear surface (s2) of the second planet gear (42). Below are the kinematic ratio calculations for the C configuration (C)

In FIG. 4, a schematic representation of a possible D configuration (D) of the orbicular gear mechanism (10) is provided. In the D configuration (D), the orbicular gear mechanism (10) includes a first planet gear (41) and a second planet gear (42) positioned on a single carrier (46) in such a way that the planet gear surfaces (s2) are in contact with each other and they rotate around parallel longitudinal axes (y). Both the first planet gear (41) and the second planet gear (42) are attached to the same carrier (46). On the carrier (46), there are separate and parallel shafts (45) for the first planet gear (41) and the second planet gear (42). In the D configuration (D), both the first face gear (20) and the second face gear (30) are positioned in the sun gear direction (o2). Therefore, both the first face gear (20) and the second face gear (30) function as sun gears. The face gear surface (s1) of the first face gear (20) is in contact with the planet gear surface (s2) of the first planet gear (41). The face gear surface (s1) of the second face gear (30) is in contact with the planet gear surface (s2) of the second planet gear (42). With this structure, the D configuration (D) is essentially similar to the C configuration (C), and the difference between them lies in the positioning of the first face gear (20) and the second face gear (30). Below are the kinematic ratio calculations for the gear ratio for the D configuration (D).

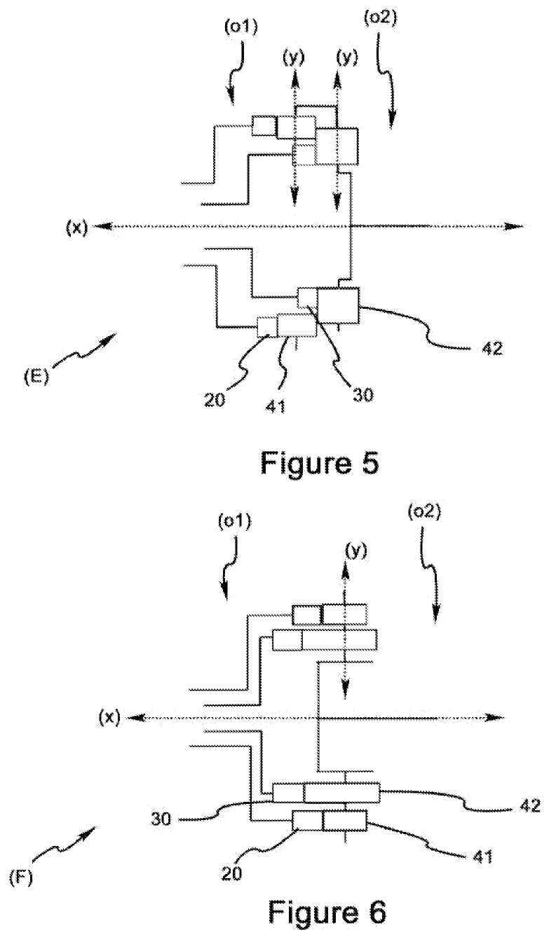

In FIG. 5, a schematic representation of a possible E configuration (E) of the orbicular gear mechanism (10) is provided. In the E configuration (E), the orbicular gear mechanism (10) includes a first planet gear (41) and a second planet gear (42) positioned on a single carrier (46) in such a way that the planet gear surfaces (s2) are in contact with each other and they rotate around parallel longitudinal axes (y). Both the first planet gear (41) and the second planet gear (42) are attached to the same carrier (46). On the carrier (46), there are separate and parallel shafts (45) for the first planet gear (41) and the second planet gear (42).

In the E configuration (E), both the first face gear (20) and the second face gear (30) are positioned in the ring gear direction (o1). Therefore, both the first face gear (20) and the second face gear (30) function as ring gears. The face gear surface (s1) of the first face gear (20) is in contact with the planet gear surface (s2) of the first planet gear (41). The face gear surface (s1) of the second face gear (30) is in contact with the planet gear surface (s2) of the second planet gear (42). With this structure, the E configuration (E) is essentially similar to the C configuration (C), and the difference between them lies in the positioning of the first face gear (20) and the second face gear (30). Below are the kinematic ratio calculations for the gear ratio for the E configuration (E).

In FIG. 6, a schematic representation of a possible F configuration (F) of the orbicular gear mechanism (10) is provided. In the F configuration (F), the orbicular gear mechanism (10) includes at least one shaft (45) extending longitudinally on a carrier (46). Both the first planet gear (41) and the second planet gear (42) are positioned on the mentioned shaft (45). The planet gear surface (s2) of the first planet gear (41) is in contact with the face gear surface (s1) of the first face gear (20). The planet gear surface (s2) of the second planet gear is in contact with the face gear surface (s1) of the second face gear (30).

In the F configuration (F), both the first face gear (20) and the second face gear (30) are positioned in the ring gear direction (o1). Therefore, both the first face gear (20) and the second face gear (30) function as ring gears. The F configuration (F) is similar to the B configuration (B), with the difference being in the positioning of the first face gear (20) and the second face gear (30). Below are the kinematic ratio calculations for the gear ratio for the F configuration (F).

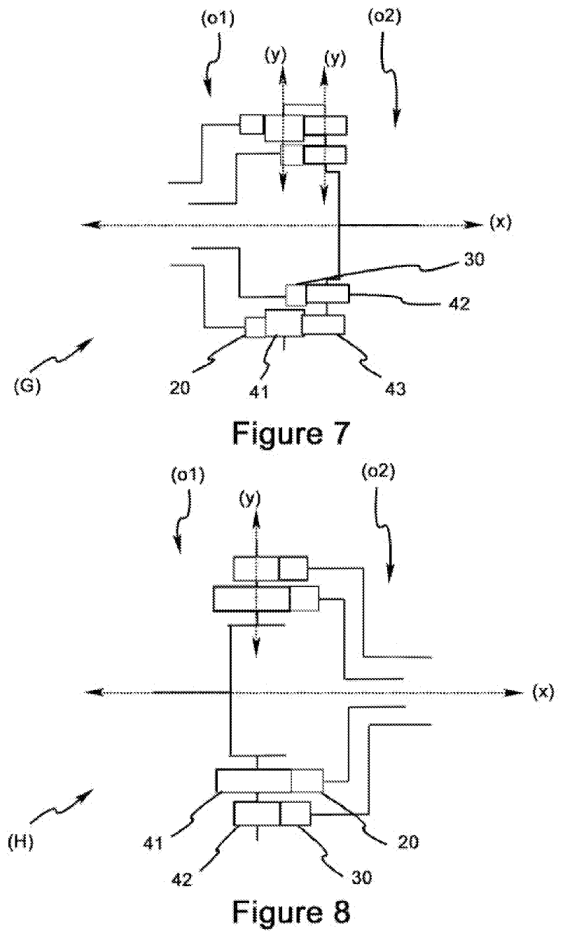

In FIG. 7, a schematic representation of a possible G configuration (G) of the orbicular gear mechanism (10) is provided. In the G configuration (G), the orbicular gear mechanism (10) includes at least one first planet gear (41), at least one second planet gear (42), and at least one third planet gear (43). The carrier (46) contains at least two parallel extending shafts (45). The first planet gear (41) is positioned on one of the shafts (45), the second planet gear (42) is positioned on another shaft (45), and the mentioned third planet gear (43) is positioned on the same shaft (45) as the second planet gear (42). Therefore, while the second planet gear (42) and the third planet gear (43) are on the same shaft (45), the first planet gear (41) is positioned on the other shaft (45) that extends parallel to it. The planet gear surface (s2) of the first planet gear (41) is located between the face gear surface (s1) of the first face gear (20) and the planet gear surface (s2) of the third planet gear (43). The face gear surface (s1) of the second face gear (30) is in contact with the planet gear surface (s2) of the second planet gear (42). Below are the kinematic ratio calculations for the gear ratio for the G configuration (G).

In FIG. 8, a schematic representation of a possible H configuration (H) of the orbicular gear mechanism (10) is provided. In the H configuration (H), the orbicular gear mechanism (10) includes at least one shaft (45) extending longitudinally on a carrier (46). Both the first planet gear (41) and the second planet gear (42) are positioned on the mentioned shaft (45). The planet gear surface (s2) of the first planet gear (41) is in contact with the face gear surface (s1) of the first face gear (20). The planet gear surface (s2) of the second planet gear (42) is in contact with the face gear surface (s1) of the second face gear (30).

In the H configuration (H), both the first face gear (20) and the second face gear (30) are positioned in the sun gear direction (o2). Therefore, both the first face gear (20) and the second face gear (30) function as sun gears. The H configuration (H) is similar to the B configuration (B), with the difference being in the positioning of the first face gear (20) and the second face gear (30). Below are the kinematic ratio calculations for the gear ratio for the H configuration (H).

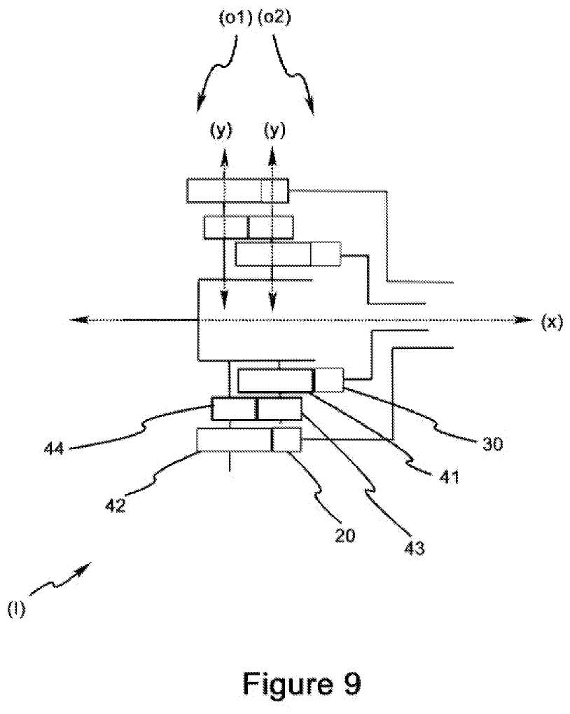

In FIG. 9, a schematic representation of a possible I configuration (I) of the orbicular gear mechanism (10) is provided. In the I configuration (I), the orbicular gear mechanism (10) includes a first face gear (20) with its face gear surface (s1) in contact with the planet gear surface (s2) of the first planet gear (41). The second face gear (30) has its face gear surface (s1) in contact with the planet gear surface (s2) of the second planet gear (42). On the carrier (46), there are two parallel extending shafts (45).

On one of the shafts (45), there is at least one fourth planet gear (44) positioned along with the first planet gear (41). On the other shaft (45), there is at least one third planet gear (43) positioned along with the second planet gear (42). In the I configuration (I), the planet gear surfaces (s2) of the third planet gear (43) and fourth planet gear (44) are in contact with each other. With this structure, different power transmission ratios can be achieved between the first planet gear (41) and the second planet gear (42) through the third planet gear (43) and fourth planet gear (44).

In the I configuration (I), both the first face gear (20) and the second face gear (30) are positioned in the sun gear direction (o2). Therefore, both the first face gear (20) and the second face gear (30) function as sun gears. Below are the kinematic ratio calculations for the gear ratio for the I configuration (I).

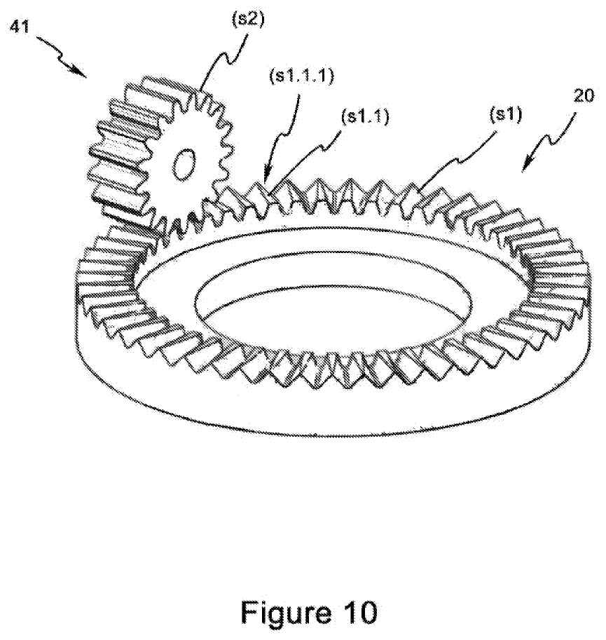

In FIG. 10, schematic representations of the orbicular gear mechanism (10) with the first face gear (20) and the first planet gear (41) positioned in a manner where the face gear surface (s1) of the first face gear (20) contacts the planet gear surface (s2) of the first planet gear (41) are provided. In the orbicular gear mechanism (10), the face gear surface (s1) features a conical shape form (s1.1.1). This conical shape form (s1.1.1) creates centric effects on the planet gears. The conical shape form (s1.1.1) describes the tapering of the tooth tip (s1.1) as it moves away from the central axis (x). This allows for the development of high-speed circular mechanisms compared to traditional epicyclic mechanisms. Additionally, any thermal expansion due to heat generation is compensated for by slight radial movement of the planet gears, ensuring smooth operation of the gears under all temperature conditions.

All these configurations and potential variations derived from them offer the orbicular gear mechanism (10) the ability to achieve compactness, weight reduction, improved load distribution, reduced stress concentrations, low backlash configurations, and low-ratio parallel-shaft gearboxes. These advantages make the orbicular gear mechanism (10) an alternative to traditional planetary gear arrangements in various industries and applications.

In more detailed terms, in the invention of the orbicular gear mechanism (10), increasing the face width of the gears does not affect the width of the gear housing, resulting in a compact size overall. This compactness is particularly advantageous in industries such as automotive, electric vehicles, aviation, and aerospace where size is limited, and weight reduction is crucial, especially in high-speed and high-torque applications.

In the orbicular gear mechanism (10), the possibility to increase the number of planet gears compared to the reduction ratio reduces the overall size and mass of the gear housing. Consequently, the orbicular gear mechanism (10) becomes suitable for applications where weight savings are necessary, such as aircraft and spacecraft.

Compared to traditional epicyclic mechanisms, the orbicular gear mechanism (10) provides an enhanced load distribution. The distribution of forces and torque within the gear housing is more efficient and evenly distributed among the gears. This reduces stress concentrations on specific components, ensuring better reliability and potentially longer service life.

In high-speed applications of the orbicular gear mechanism (10), centrifugal load effects occur along the axial direction of each planet gear. This implies that a small-sized bearing assembly can withstand the entire effect independently of radial transmission loads, resulting in improved load distribution.

Due to the axial mounting flexibility caused by the center distance between planet gear and face gear mesh in the orbicular gear mechanism (10), orbicular gear mechanisms can be easily assembled with low backlash/backlash free configurations. This makes the orbicular gear mechanism (10) suitable for low-backlash robotic applications.

The orbicular gear mechanism (10) allows the development of low-ratio (below 1.7) parallel-shaft gearboxes. This provides an advantage in minimizing the size of loading systems for various mechanical closed loop loading systems.

The scope of the invention is defined in the appended claims and is not limited solely to what has been described in this detailed explanation for illustrative purposes. It is evident that a person skilled in the art could create similar configurations based on the above description without departing from the main theme of the invention.

### REFERENCE NUMBERS GIVEN IN THE FIGURE

10 Orbicular Gear Mechanism
20 First Face Gear
30 Second Face Gear
40 Planet Gear Group
41 First Planetary Gear
42 Second Planetary Gear
43 Third Planetary Gear
44 Fourth Planetary Gear
45 Shaft
46 Carrier
(s1) Face Gear Surface
(s1.1) Tooth Tip
(s1.1.1) Conical Shape Form
(s2) Planet Gear Surface
(x) Center Axis
(y) Axial Axis
(o1) Ring Direction
(o2) Sun Direction
(A) A Configuration
(B) B Configuration
(C) C Configuration
(D) D Configuration
(E) E Configuration
(F) F Configuration
(G) G Configuration
(H) H Configuration
(I) I Configuration

1. An orbicular gear mechanism configured to provide motion transfer, characterized by: having at least one first face gear and at least one second face gear to rotate around a central axis and transfer motion therebetween, at least one planetary gear group connected to at least one shaft located on a carrier is connected to the first face gear and said second face gear for changing the gear ratios, said planetary gear group comprises at least one first planetary gear and at least one second planetary gear each capable of rotating around themselves and each extending along at least one longitudinal axis assumed to be perpendicular to the central axis, said first planetary gear and said second planetary gear are connected to the same carrier.

2. An orbicular gear mechanism according to claim 1, characterized by at least one of the first face gear and the second face gear having teeth in a conical form on a face gear surface.

3. An orbicular gear mechanism according to claim 1, characterized by both the first planetary gear and the second planetary gear being arranged on the same shaft, the first face gear being in contact with a face gear surface of the first planetary gear with a face gear surface of the first face gear, the second face gear being in contact with a face gear surface of the second planetary gear with a face gear surface of the second face gear, the first face gear being positioned in a ring direction, and the second face gear being positioned in a sun direction.

4. An orbicular gear mechanism according to claim 1, characterized by both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, the first face gear being positioned in a ring direction, and the second face gear being positioned in a sun direction.

5. An orbicular gear mechanism according to claim 1, characterized by both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, both the first face gear and the second face gear being positioned in a sun direction.

6. An orbicular gear mechanism according to claim 1, characterized by both the first planetary gear and the second planetary gear being located on two separate shafts extending parallel to each other along longitudinal axes on the carrier, the first face gear being in contact with a face gear surface of the first planetary gear with a face gear surface of the first face gear, the second face gear being in contact with a face gear surface of the second planetary gear with a face gear surface of the second face gear, both the first face gear and the second face gear being positioned in a ring direction.

7. An orbicular gear mechanism according to claim 1, characterized by both the first planetary gear and the second planetary gear being aligned on the same shaft, the first face gear being in contact with a face gear surface of the first planetary gear with a face gear surface of the first face gear, the second face gear being in contact with a face gear surface of the second planetary gear with a face gear surface of the second face gear, and both the first face gear and the second face gear being positioned in a ring direction.

8. An orbicular gear mechanism according to claim 1, is characterized by both the first planetary gear and the second planetary gear being aligned on parallel longitudinal axes on two separate shafts, the first face gear being in contact with a face gear surface of the first planetary gear with a face gear surface of the first face gear, the second face gear being in contact with a face gear surface of the second planetary gear with a face gear surface of the second face gear, at least one third planetary gear being in contact with the first planetary gear and positioned on the same shaft as the second planetary gear and adjacent to the second shaft in a manner that a face gear surface of the third planetary gear contacts a face gear surface of the first planetary gear, and both the first face gear and the second face gear being positioned in a ring direction.

9. An orbicular gear mechanism according to claim 1, is characterized by both the first planetary gear and the second planetary gear being aligned on the same shaft, the first face gear being in contact with a face gear surface of the first planetary gear with a face gear surface of the first face gear, the second face gear being in contact with a face gear surface of the second planetary gear with a face gear surface of the second face gear, and both the first face gear and the second face gear being positioned in a sunward direction.

10. An orbicular gear mechanism according to claim 1, characterized by both the first planetary gear and the second planetary gear being connected to two separate shafts that are parallel to each other in the longitudinal direction, the first face gear is in contact with a face gear surface of the first planetary gear with a face gear surface of the first face gear, and the second face gear is in contact with a face gear surface of the second planetary gear with a face gear surface of the second face gear, the first planetary gear on its shaft includes at least one fourth planetary gear adjacent to the first planetary gear, and the second planetary gear on its shaft includes at least one third planetary gear adjacent to the second planetary gear, the third planetary gear and fourth planetary gear are in contact with each other with their planetary gear surfaces.
